(19) United States
(12) Patent Application Publication
(10) Pub. No.: US 2011/0087961 A1
(43) Pub. Date: Apr. 14, 2011

(54) Method and System for Assisting in Typing

(75) Inventors: Eitan Fitusi, Modi'in (IL); Noam Rotem, Lapid (IL)

(73) Assignee: A.I TYPE LTD., Emek Hefer (IL)

(21) Appl. No.: 12/900,541

(22) Filed: Oct. 8, 2010

Related U.S. Application Data
(60) Provisional application No. 61/250,523, filed on Oct. 11, 2009.

(51) Int. Cl. G06F 17/21

(52) U.S. Cl. 715/261

(57) ABSTRACT

The invention relates to a computerized system for predicting completions to input text which is typed by a user to a text-oriented active application within a client computer, which comprises: (a) an off-line server that gathers texts from textual repositories, analyzes and processes the same to produce entries for an off-line database, said off-line server updates periodically a real time database of a real time server; (b) a real-time prediction server for receiving from an agent at said client computer serial requests for predictions, extracting in response to each of said requests one or more text predictions from tables within said real time database, and for conveying said one or more text predictions to said agent, wherein each of said text predictions comprises one or more words; (c) said real time database which comprises one or more tables containing word combination entries of various sizes, wherein each of said entries is associated with a weight which is used to estimate the probability for this combination to complete the typed text as included in the respective request for prediction; and (d) said agent which extracts in real time each present user typing to said text-oriented application, produces requests for prediction for new typing, sends the same to said prediction server, receives in response said one or more text predictions, and presents to said user said one or more text predictions for selection.

### REFERENCE TO CO-PENDING APPLICATION

Priority is claimed to U.S. provisional patent application Ser. No. 61/250,523, filed on Oct. 11, 2009.

### FIELD OF THE INVENTION

The present invention relates to the field of typing assistance. More particularly, the invention relates to a system for predicting intended text, and proposing alternatives for auto-complete.

### BACKGROUND OF THE INVENTION

Methods for aiding users while typing within a computer application (such as a word processor, email, etc.) have been developed for more than a decade now. Such methods become increasingly necessary as the use of computers becomes more ubiquitous and the amount of texts that users are required to type increase. Typically, such methods rely on some kind of process that runs in the system as a background low-priority process, which is able to identify that a user presently provides a text. Providing the text by the user is referred hereinafter as “typing”. The user can provide the textual input to the computer in any way, via a standard keyboard, a voice recognition interface, a touch-sensitive screen overlaid on top of a graphical image of a keyboard, a system that detects a motion of a pen in combination with handwriting recognition software, Optical Character Recognition techniques (OCR), or any other known method.

Some well-known algorithms such as the so called Most Recently Used (MRU) text completion algorithm offer aid to predict the text that the user wishes to type, and suggest several alternatives for completion.

U.S. Pat. No. 5,805,911 (Miller) discloses a method of providing and selecting multiple text predictions from text entered from multiple windows of a computer system using an application-independent text prediction system. Several “prediction modules” provide a weighted list of predictions, based on an estimation of the probability that the completion text will be entered by the user.

U.S. Pat. No. 5,896,321 (Miller et al.) discloses a method of word prediction system that produces a prioritized list of word predictions by comparing the partial data entry to the entries in a dictionary to obtain a list of feasible words. The word prediction system submits the list of feasible words to plurality of word prediction experts within the computer and obtains a word prediction score for each entry in the list of feasible words from each expert. The word prediction system positions each word prediction in the prioritized list of word predictions based on a computed indication of likelihood of being a correct completion.

U.S. Pat. No. 6,377,965 (Hachamovitch et al.) discloses a word completion system that can automatically predict unrestricted word completions for data entries in an unstructured portion of a data file. A user interface allows the user to customize each suggestion list on an on-going basis. Each suggestion list may contain dynamic word completions that are tied to dynamic parameters maintained by the computer system, such as the time, date, registered user, etc. Each suggestion list may also be tied to contextual information, such as structured data fields or context labels assigned manually or by a document-creation aid.

U.S. Pat. No. 7,293,231 (Gunn et al.) discloses a method of entering and searching for text through a combination of entering one or more characters and using a search list to display a list of selectable completion candidates based on the partial text entry.

The traditional methods of text completion or prediction mentioned above attempt to identify the text already typed and typically suggest a single word that is likely to comprise the word that the user currently types. The user can then either select the suggested word or go on and complete typing the whole word. Typically, those prediction methods rely on a database stored in the client computer. The database is built on general assumptions about some specific language currently in use by the user, namely a dictionary, or an extension of it. In addition, some methods learn preferences and recurrent textual patterns associated with a given user, and enhance the use of the database for better prediction, based on past experience with the user. However, such databases are large and their contents remain mostly unused.

Another type of text prediction methods known in the art is related to specific web applications, such as, for example Google's completion of URLs or other Internet-oriented elements. In this method, Google uses its own resources, as well as usage statistics, in order to predict and suggest possible word, search expressions, and URLs.

The existing types of text prediction methods suffer from several drawbacks. The methods which rely on a user database are language-dependent, oriented to a specific user, and consume relatively high amounts of internal memory, storage space and other computing resources which are usually way beyond those necessary for the text prediction tasks. The second type of text prediction methods that relates to specific web applications is not application-independent.

It is therefore an object of the present invention to provide a system for aiding users to type their input text to any text-oriented application, which is adapted to read and understand users textual composing, predict text input, and automatically offer words and sentences completion in the current paragraph context.

It is another object of the present invention to provide a language-independent text prediction system.

It is another object of the present invention to provide a global system adapted to share knowledge between users and learn from the Web.

It is another object of the present invention to suggest the most updated and relevant text to the user.

It is another object of the present invention to suggest informal words and expressions which are commonly used by the public.

It is another object of the present invention to allow users to provide their text in a desired jargon, for example, an unskilled person may write correctly a legal-oriented text.

It is still another object of the present invention to provide a system which does not load the user computing resources.

Other objects and advantages of the invention will become apparent as the description proceeds.

### SUMMARY OF THE INVENTION

The invention relates to a computerized system for predicting completions to input text which is typed by a user to a text-oriented active application within a client computer, which comprises: (a) an off-line server that gathers texts from textual repositories, analyzes and processes the same to produce entries for an off-line database, said off-line server updates periodically a real time database of a real time server; (b) a real-time prediction server for receiving from an agent at said client computer serial requests for predictions, extracting in response to each of said requests one or more text predictions from tables within said real time database, and for conveying said one or more text predictions to said agent, wherein each of said text predictions comprises one or more words; (c) said real time database which comprises one or more tables containing word combination entries of various sizes, wherein each of said entries is associated with a weight which is used to estimate the probability for this combination to complete the typed text as included in the respective request for prediction; and (d) said agent which extracts in real time each present user typing to said text-oriented application, produces requests for prediction for new typing, sends the same to said prediction server, receives in response said one or more text predictions, and presents to said user said one or more text predictions for selection.

Preferably, said text predictions are taken from the group consisting of: one or more words, a sentence, and a paragraph.

Preferably, one or more of said requests for predictions contain user personal data, wherein said real time database comprises plurality of characteristic sub-databases, and wherein said prediction server selects one or more specific sub-database based on said personal data.

Preferably, said real time database comprises plurality of characteristic sub-databases, and wherein said prediction server evaluates the user typing as included in said requests to determine the most appropriate one or more sub-databases to use for extracting said text predictions.

Preferably, said characteristic sub-databases are differentiated by jargon, language, user profile, and type of application.

Preferably, said textual repositories are Internet web sites to which said off line server crawls, and extracts text from pages of said web sites.

Preferably, some entries that are produced by the off-line server include variables that are thereafter replaced at the client computer either by the user or by the agent.

Preferably, the text predictions are introduced to the user within a GUI at the active application.

Preferably, the system further comprises a dictionary for a second language, and wherein the client agent also displays to the user within the GUI a translation of the text predictions to said second language.

Preferably, the agent is application-independent, and wherein it is adapted to determine and operate on said one active application from among the plurality of applications that are operative at the user computer.

Preferably, the tables contain word combinations of between one word length for completing one word, and up to a length of several hundreds of words for completing entire paragraph.

In an embodiment of the invention, which is designed for use in an organization, the system further comprises an organizational real time server which in turn comprises an internal real time database, said internal real time database comprises terms, words, and expressions that are specific to the organization, and wherein said organizational real time server further communicates with said real time server for providing together text predictions to the client.

The invention also relates to a method for suggesting completions for an input text typed to a text-oriented application running at a user computer, the method comprises: (a) receiving input text from a text input device; (b) defining, based on the input text, a request for prediction task in the computer system; (c) sending the request to prediction to a remote real time prediction server for remote execution; (d) extracting by said prediction server from a real time database one or more text predictions, and sending them to an agent within a user computer; and (e) receiving said one or more text predictions by said agent, and displaying them to the user for selection.

### BRIEF DESCRIPTION OF THE DRAWINGS

In the drawings:

FIG. 1 schematically illustrates a block diagram of the present invention;

FIG. 2 is an example of improving query results by utilizing the present invention;

FIG. 3 illustrates in a more detailed block diagram form the operation of the real time server; and

FIG. 4 illustrates in a general block diagram form a possible deployment of the invention within an organization.

### DETAILED DESCRIPTION OF THE INVENTION

Unless specifically stated otherwise, throughout the specification, terms such as “processing”, “computing”, “calculating”, “determining”, “generating”, “activating”, “reading”, “writing”, “classifying”, “allocating” or the like, refer to the action and processes of a computer that manipulate and transform data into other data, said data represented as physical, such as electronic, quantities and representing the physical objects.

The term “computer” should be expansively construed to cover any kind of electronic device with data processing capabilities, including, by way of non-limiting example, personal computers, servers, computing systems, communication devices, hardware appliance, storage devices, processors (e.g. digital signal processor (DSP), microcontrollers, field programmable gate array (FPGA), application specific integrated circuit (ASIC), etc.), and other electronic computing devices.

The operations in accordance with the teachings hereinafter may be performed by a computer specially constructed for the desired purposes or by a general purpose computer specially configured for the desired purpose by a computer program stored in a computer readable storage medium.

The present invention discloses a method and system for assisting in typing. More specifically, the system of the present invention predicts the next text that the user plans to insert, and proposes one or more alternatives for completion. The text is predicted according to the context of the previously typed text and in the broader sense, the context of the typed text. The method and system of the present invention is language independent, application independent, accurate, user-friendly, operates in real time, and non-intrusive.

The present invention is implemented with very low consumption of internal computer resources and without requiring to locally storing massive databases, dictionaries, or other subject matter which is relevant to the prediction. Moreover, the invention can suggest entire sentences or even paragraphs, and can be configured to provide prediction in specific jargons, such as legal jargon, sports-oriented jargon, engineering jargon, etc. The invention is adapted to provide prediction of one or more words even before the first letter of that word has been typed into the application.

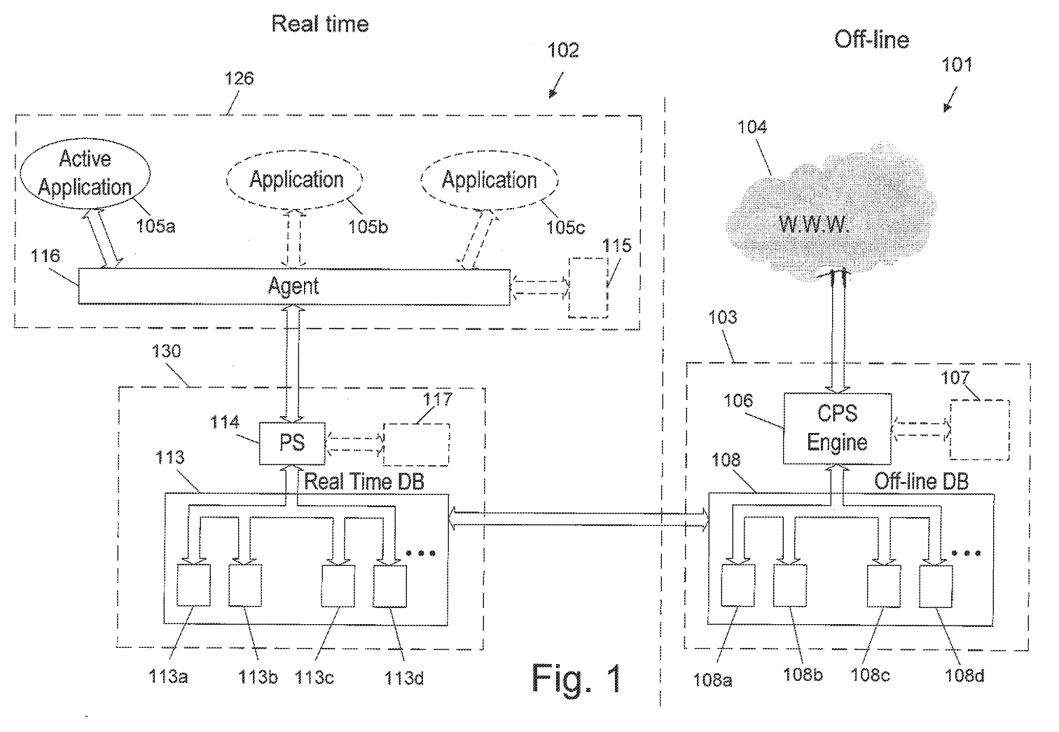

FIG. 1 describes in block diagram form the typing assistance system according to one embodiment of the invention. The system is divided into two sections, an “off-line” section 101, and a “real-time” section 102. The “off-line” processing system 103 processes data typically from World Wide Web (WWW) 104 in order to build the appropriate data bases for the prediction. The off-line processing system uses for this purpose the off-line databases 108a, 108b, 108c, and 108d. Periodically, the off-line processing system 103 feeds and updates the real-time data bases 113 that are used by the real time prediction server 114. The client apparatus 126 is provided with a client agent 116, whose task is to communicate in real time with one active application 105a in which the user presently types. Application 105a may be any type of application in which a user types sentences, such as a word processor, a mail application, etc. The user apparatus may comprise other “inactive” applications 105b, and 105c that are inactive in the sense that the user does not presently types in them. The client agent 116 communicates also in real time with prediction server 114 in a client-server configuration.

The off-line processing system 103 comprises a Crawling and Parsing Server (CPS) 106 that “crawls” into many sites of the Web in a known in the art manner, and collects data according to predefined collecting parameters (e.g., language, category, style, specific sites, etc.). Said predefined collecting parameters are stored in collecting parameters storage 107. The crawling can be performed randomly or according to a list of predefined sites (in the case of focusing in a specific style or specific textual organization). In order to refrain from any undesired sites, collecting parameters storage 107 comprises screening parameters based on keywords, and a list of blocked sites. CPS 106 is adapted to prioritize sites with a high ratio of text compared to other non-textual elements within the page, and filter out sites with provocative or unwanted expressions. The collected data is filtered using linguistic tools and rules. The data is further analyzed and parsed using Artificial Intelligence (AI). It should be noted that crawling websites is only an example, as a mass of text documents that their origin is not from the web can be analyzed locally by the CPS 106 as well.

In one embodiment, the Web page structure is analyzed within the sites themselves. The page is divided into different elements (e.g., header, navigation bar, side bar content, etc.). The text in the Web page is learned from the main content of the page. Analytic tools are used by CPS 106 for understanding HTML consecutive sections (including sections that are punctuated by HTML coding). The connectivity of the text is evaluated for understanding whether the text as constructed is relevant or not.

Connectivity tools estimate the quality and connectivity of various combinations of words in the text, and filter out text in which the overall level of connectivity is low. The level of connectivity is estimated based on previous learning schema. In the next steps, the system analyzes the text sections which differentiates words and phrases, and learns sections and combinations of words and phrases. This information is saved and processed with other information from the various sites.

The site itself is also studied by a combination of indexes and keywords, distinguishing language engines, data and other information. All of these are cross-referenced to the profile page, content, language, writing style, date of writing, and geographic location. Information on the page itself is linked to textual information to better understand the relationship between text segments and combinations to other information (such as, language, content, date, etc.).

The analyzed data is stored in a structural manner within off-line database 108. The data within the off-line database 108 is distributed within several sub-databases 108a-108d, according to different prediction types. For example, sub-database 108a may comprise, for example, legal-oriented data, sub-database 108b may comprise Italian-oriented data, sub-database 108c may comprise youth-oriented data, and sub-database 108d may comprise engineering oriented data, etc. Each sub-database predicts the text according to its orientation. Typing the words “I would like to drink . . . ” may be completed differently depending on the specific source of the data (i.e., the specific sub-database) that is used for completing the sentence. If the source for completing the sentence is sub-database 108b, namely Italian-oriented, the options suggested to the user might be “I would like to drink espresso/wine/lemoncello”. On the other hand, if the source for completing the sentence is taken from sub-database 108c, namely from the youth-oriented sub database, the options suggested to the user might be “I would like to drink Soda/Cola/Chocolate milk”. In order to create the oriented databases, CPS 106 collects data from the Web 104 while noticing, among others, from which site the data is collected, to which country the site relates, the specific language of the text, the field of the site, jargon, etc.

The collected data is stored in the first phase only within the off-line database 108. In the initial stages of the off-line process the data is considered as being of low reliability. Therefore, it is not “published” yet, i.e., it is not yet conveyed to the real time databases 113. Only when the data is considered reliable above a predefined threshold, the relevant data is conveyed to the appropriate database 108. The threshold may be, for example, a specific number of appearances of a specific expression. As said, when the expression becomes reliable above the predefined reliability threshold, the expression is copied to one or more of the real-time databases 113. The real time databases 113 may be copied several times along the globe in order to meet the real time requirement, particularly to ensure a short time round trip communication between the client agent 116 and PS 114. Moreover, several of real-time prediction servers 114 may be used respectively along the globe, for the same purpose.

The client agent 116 monitors the typing of the user within the active application 105a, and it further conveys in real time the user typing prediction server (hereinafter, PS) 114. The PS utilizes database 113 to provide the predicted text, and more preferably, it provides several optional suggestions of predicted text to the user by means of a GUI which is activated on top of the active application 105a. In one embodiment, the real time server 130 may also have a geographical orientation. For example, a specific real time server serves users from Italy, another may serve users from the UK, etc. Although several of the real time databases 113 in these servers may be the same, others may be particularly adapted to meet the specific origin of the user. The databases 113 may be divided also according to various categories (characteristics) e.g., language, style, jargon, etc. Users, who need the prediction services of the present invention, whether they type on a handheld device, a laptop, a smart phone, or a conventional computer, can connect to the nearest and most oriented PS that best meets their needs. In one embodiment, once a user connects to a PS for the first time, the system stores his profile for providing him future prediction services that best meet his profile. Preferably, the user basic profile is stored, and is used in all future sessions of the user, for the purpose of activating for him those databases that are most adapted for his profile. The stored user profile may include also a type of the user license and those services to which he is entitled.

PS 114 suggests to the user the word and/or sentence completion according to the data in the real time database 113. Real time database 113 is updated from time to time, and synchronized with the off-line database 108. Besides dictionary vocabulary, and formal language data, local database 113 also contains informal words and expressions that are used by the public, have been verified and passed the reliability threshold.

In order to reduce redundancy, and to answer ever more user needs, an off-line information process takes place at the off-line system 103. The purpose of the process is to identify textual templates with variables. In this process, connections (i.e., sequences) in which one or more words are not an essential part of the link itself are tracked. For example “I took a walk with Danny yesterday on the beach” or “I took a walk with David yesterday on the beach”. In both of these cases the names “Danny” or “David” are not significant. The structure in this context is “I took a walk with [name] yesterday on the beach” in which “[name]” can be replaced by any word that falls under the criteria of names.

This process greatly improves the ability to find and link connections (i.e., sequences) and also significantly reduces the amount of information needed to be handled. Another information reduction is achieved by eliminating very weak links from the real time database 113. For example, infrequent sequences may be considered as “weak”. This process significantly filters out “noises”, and reduces the likelihood of erroneous examples or typing errors. “Weak” sequences are preferably saved in the off-line database 108, in case that they become stronger in the future.

In one embodiment the initial off-line crawling process is performed during several months. During this period, the system can “learn” from more then 10 million sites. After the initial data collection, and in order to keep the information in the databases updated, the off-line system 103 continues to accumulate data from new sites while updating the databases. In one embodiment, newly collected data prioritize older data. As an example, the system of the present invention will offer as a sequel for the word “President” the word “Obama” as the first prediction, while “President Bush” will be offered only as later option (or first selection when clicking the “B” letter).

The invention supports an automatic self learning process of improving the prediction. The longer the database and off-line servers 103 operate, more actual patterns are stored in the database, resulting in more accurate prediction.

The algorithm can even be utilized to improve existing speech recognition systems and other automatic text generation systems such as automatic translation and word prediction as mentioned earlier. In the case that a speech recognition is used, while the speech is converted to a word in the screen, the system of the invention provides proposals for the next words, that the user may receive either via the keyboard, or by means of providing a speech command.

In one example, the first proposed sequel for “war in” is “Iraq”, as this word has been found as most commonly used in the scanned texts. As a second choice the system suggests “Vietnam”. These suggestions are provided the occurrence of “war in Iraq” is highest within the scanned sites. More specifically, when the system has no prior knowledge regarding the text, the suggestions are provided according to the most common sequel in its databases and among the scanned sites. However, the system changes the priority of the offers as the typing proceeds. For example, if in the first occurrence the user has accepted “Vietnam” rather than “Iraq” (although “Vietnam” was initially considered as the second offer), in the second occurrence of “war in” in the typed document the system will raise “Vietnam” to be provided as the first priority, rather than “Iraq”. More specifically, the system dynamically changes its proposed alternatives based on the progression of the text, the user current mood as determined from the text, his previous style, expressions, and any other previously written text. In other words, when the user inserts his text, the system analyzes his insertions and adapts the suggestions to the text already typed by the user. For example, if the text includes the word Vietnam or data regarding the war in Vietnam, the first proposed sequel for “war in” will be Vietnam. New words or events of global significance are immediately expressed in the system, hence the continuous off-line information processing and off-line updates are very important in increasing the score of the prediction (the predictions with the highest scores will be suggested to the user).

As mentioned hereinbefore, the prediction server 114 suggests to the user suggestions for completion according to the data in the real time database 113. The real time database contains a variety of types of connections. The prediction server, in real time draws connections from the different oriented databases, and performs a merging process aiming to present the user the most relevant suggestions in view of the current situation.

The different word connections are created by analyzing the text written by the user. Based on the smart prediction process of the invention, the system presents to the user the most relevant suggestions that assist the user in putting words together. It has been found by the inventors that in an average text, the present invention saves about 85% of the keystrokes. The suggestions are based on content driven text rather than on single word driven. Thus, an average of 0.5 to 0.8 characters is required to be typed for each word in the document, namely, for some of the suggested words, less than one character on average is needed for an accurate prediction. The average of the characters required for an accurate prediction constantly improves, as the databases increase. The method according to the present invention is adapted to suggest predictions of an entire sentence or short phrases.

The merging process by which the real time server 113 decides which words or sentences will be offered to the user as suggestions continuously improves in time, in an automatic manner. The system measures the quality of the prediction, and updates properties related to the merge functions for optimal merging. The properties related to the merge functions are stored in real time database 113. The system continuously optimizes the prediction process, for example, according to feedbacks from users typing and previous selections of proposed completions. The properties in the real time database 113 are adjusted to optimize the merging.

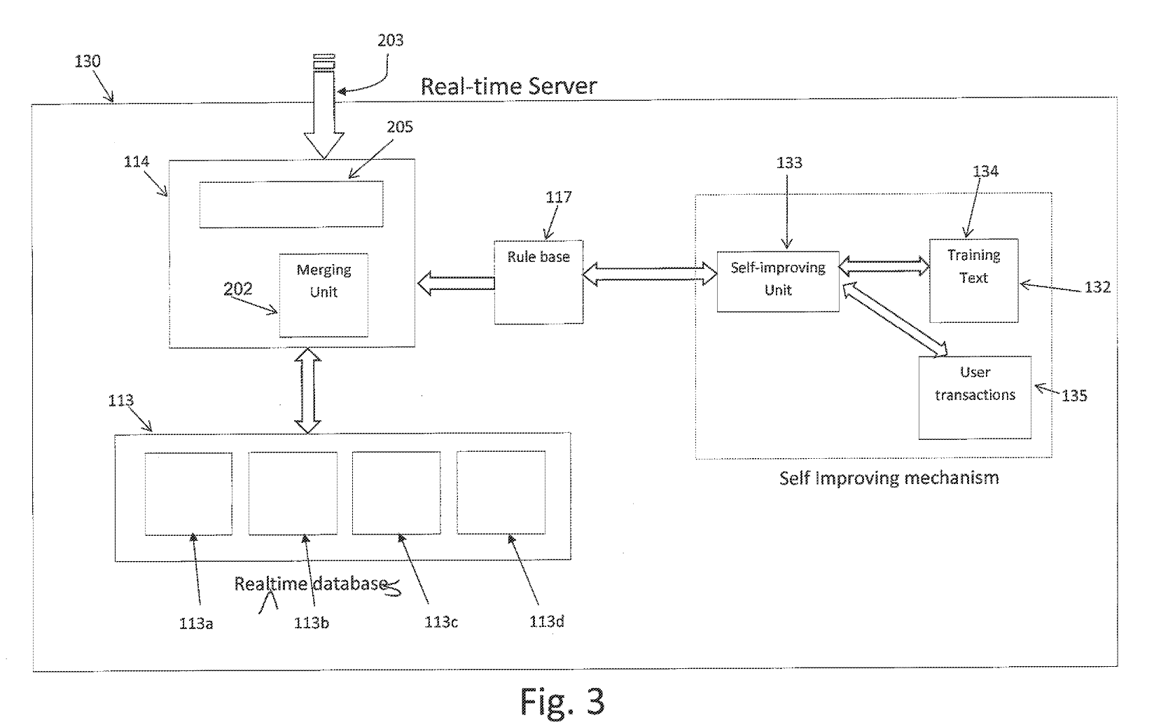

FIG. 3 describes in a more detailed block diagram form the structure and operation of the real time server 130, according to an embodiment of the present invention. The prediction server (PS) 114 receives prediction requests 203 from a user. The PS, be means of the parser 205 breaks the user request into previously typed words (context) and the presently typed word or a portion thereof (hint). To satisfy the request the PS uses the context and hint to retrieve multiple prediction alternatives from relevant multiple real time databases 113. Generally, this process yields an excessive amount of predictions. The merging unit 202 is responsible for selecting and prioritizing the best predictions to be sent to the user. The logic of how to score predictions and decide between them is encapsulated within the rule base 117.

Still with respect to FIG. 3, the PS 114 generates prediction alternatives that match the context and hint provided in the prediction request 203. A simple example of prediction alternatives that match the hint would be words or sentences that start with the letters of the hint. In a more complex scenario, the PS 114 returns words or sentences that contain the letters from the hint anywhere, in the original order or swapped (if the user made a typo mistake). Yet another example is when the PS 114 returns words and sentences that contain letters that sound like the letters in the hint (such as ‘f’ versus ‘ph’ etc.). With these capabilities of the prediction server, the user may make common spelling mistakes and still get the right prediction from the PS 114.

The real time server 130 preferably further comprises self improving mechanism 132 for continuously tuning and improving the rule base 117. The self improving unit 133 uses a repository of training text 134 and a repository of historical user transactions, i.e., previous prediction requests the responses by the PS 114, and the actual reaction of the to these responses, for tuning the rule base 117 in order to improve future success in predictions.

Prediction alternatives are prioritized and selected by the merging unit 202 according to their scores. The score of a prediction alternative is calculated by evaluating a set of parameters (features) that each prediction alternative complies to. Each prediction alternative is assigned a score between 0 and 1 for each feature of the set. The final score of a prediction alternative is a weighted sum of its feature scores. The rule base 117 comprises the entire feature set, and the weight of each feature.

The self improving mechanism 132 is responsible for discovering the best set of feature weights that yields the most successful selection and prioritization of prediction alternatives.

In one embodiment, the real time database is divided into two parts. One part contains a relatively small database with the most frequently used and/or the most recently used words and sentences. This database enables a quick response. However, said small database in insufficient for satisfying a user request, the real time database—a full blown database is being queried.

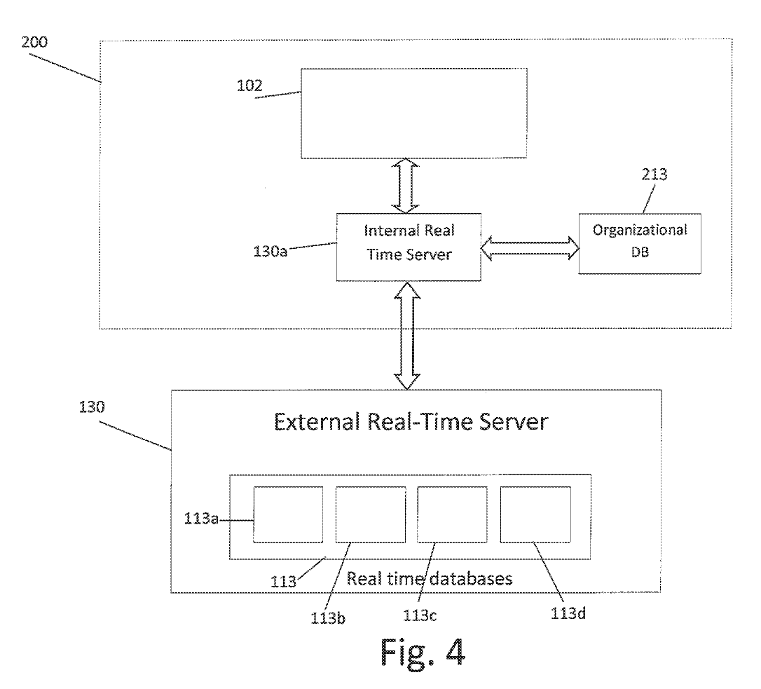

In still another alternative, when the invention is used within an organization, a dedicated real time server is deployed and populated with organizational terminology and text elements processed from organizational documentation, emails, Intranet pages etc. Prediction alternatives can be drawn from the organizational database and merged with relevant suggestions that are extracted from external real time databases 113 (as described with respect to FIGS. 1 and 3). FIG. 4 describes the structure of a system according to this alternative. The organization real time server 130a extracts suggestions from the organization internal database 213 on one hand and from the external real time server on the other hand and merges between them. In such case, the system can provide assistance to various organization clients 102 with respect to specific words, terms, and expressions that are used internally within the organization.

The following is an example of a sentence that has words with mismatch of characters: “I Cdnuolt blveiee taht I cluod aulaclty uesdnatnrd waht I was rdanieg”. Word or Outlook editors mark the mistyped words as misspelled. However, due to the high amount of wrong characters, half of the mistyped words are not even suggested with the correct word. The solution provided by the present invention essentially, does not get to the problem that other solutions get into. The desired words to be written are predicted while typing the initial characters of each word. In the following example, the underlined characters are the initial characters mistakenly typed by the client (shown in the sentence above). The invention, despite the client's errors still suggests the correct completion, namely, “I couldn't believe that I could actually understand what I was reading”. By typing the initial underlined characters, the list of suggestions shrinks down to a small set of words that helps the user to select the desired words. In the example above 3 out of the 12 words are predicted without even typing one character, and the other 6 words need only 13 characters to be typed in order to complete the entire sentence.

Beyond text prediction, the present invention offers also advanced spelling, grammar checking, and translation in any given language. The present invention finds the mistakes based on the contents of the text rather than based on a dictionary or predefined set of rules.

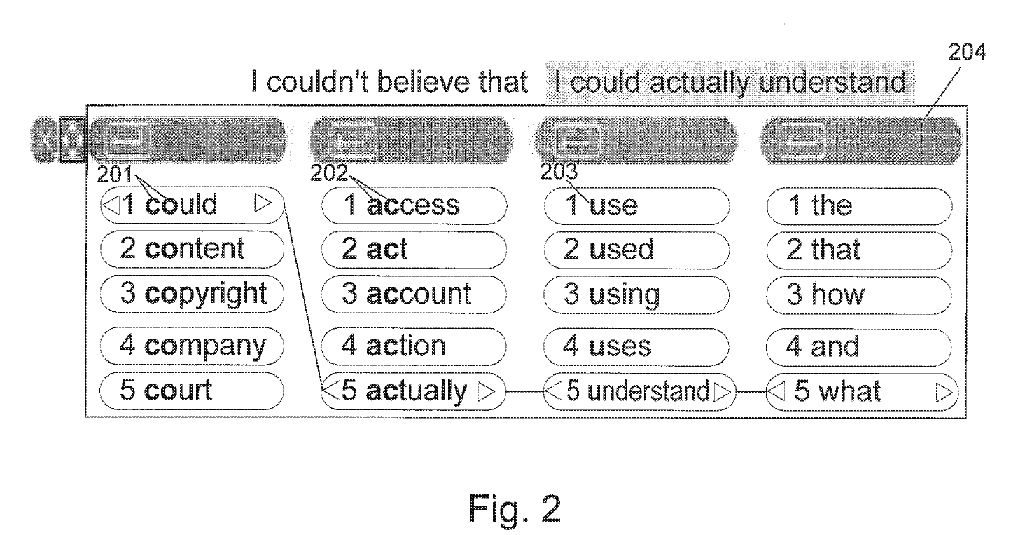

FIG. 2 is an exemplary embodiment of a drop down list of suggested words according to the context of the existing text. In this embodiment, the client regularly types the beginning of the sentence “I couldn't believe that I” and then uses the system according to the present invention to type the rest of the sentence. When the user starts typing in the specific application and types the initial characters 201-203 of some of the words, the agent 116 opens GUI 204 which offers a drop down list of suggested words according to their context in the sentence.

In still another embodiment, visual indication such as a color code may be associated with each suggestion to the user. Said indication reflects the level of confidence that the PS 114 has with respect to the suggestion, based on its previous experience. For example, a low confidence suggestion may be provided in red color.

In one embodiment the user can select one word each insertion or navigate through the GUI 204 suggestions using the direction keys in the keyboard, for example. In this example, the client initially types “co”. As a result the GUI offers the most relevant words. Using the “Down” arrow, the client chooses the word “could” and then uses the “Right” arrow to go to the next word. For the second word prediction the user types “ac” and again the GUI presents the five most appropriate words. The user then uses the “Down” arrow to navigate between the words, and the “Right” key to proceed to the next word.

According to this embodiment, the user eventually “plugs in” the entire sentence, by typing the “Enter” key while the fourth suggestion, namely “what” is marked.

The system according to the present invention is also configured to provide translation to the suggested words and the sentence so far. Providing translation “on the fly” within the GUI of predicted words helps the user confidently select the appropriate suggestion. More specifically, in an embodiment of the invention the client agent 116 comprises a dictionary for translating online its suggestions to a specific language, and assisting the client in selecting the appropriate words according to their context. Therefore, sentences are built not only in the correct words, but also in the correct grammar, while assistance is provided even to a user who is not fluent in the written language.

The client agent 116 is application independent, i.e., it operates on top of any active application (the application in which the user presently types). In one embodiments of the present invention, it is possible for the client to configure the client agent 116 and its process so that it becomes responsive and interacts only with specific applications as selected by the user. Such configuration may be performed at any point in time using the GUI provided to the client. Moreover, in still another alternative of the present invention, the client agent 116 is implemented as a plug-in which runs as part of the process of one or more specific applications, rather than a background process that communicates with the active application.

When the user switches between applications, or starts a new application the client agent 116 becomes aware of the application change, detects the cursor location within the active application, and learns the text around this position to allow context sensitive prediction.

When the client types a text into the active application 105a, the client agent 116 identifies the partial data entry. The partial data entry is displayed to the client in the usual manner, and the one or more completion suggestions are displayed in association with the partial data entry in a non-disruptive word completion field, such as a pop-up completion frame that appears directly below the partial data entry. The position, size and style of appearance of the pop-up frame can also be configured by the client, using a configuration GUI, in a manner known in the art.

The pop-up frame may be configured to suggest one or more completions, as desired by the client, to suggest one or more sequences, of one or more words, or to automatically complete the sentence based on the highest probability suggestion. It may also be configured beforehand to suggest completions that are phrased in one of a given set of styles, such as legal, sports, slangy, poetic, childish, etc. The pop-up frame may be configured to suggest completions in a language specified by the user, or to identify by itself the language in which the text is written and suggest completions only in this specific language. The client agent 116 may be configured to suggest completions while considering personal data that the user has supplied in advance to the application, such as his age, occupation, etc. Such personal data are stored in private database 115, and are used during interactions between the client agent 116 and the real time server 130, in order to select operation against the most suitable database from among the databases 113a-113d (hereinafter also referred to as sub-databases). Likewise, the client agent 116 may be configured to suggest a completion that considers the kind of application 105a which is currently active. For example, the styles of the text that are typically used in an email application, in an instant-messaging, in a social-networking situation, or in a standard word-processing application are different, and the client agent 116 transfers the information relating to the type of the active application to the PS 114, which in turn uses the appropriate databases relative to the active application from among the databases 113a-113d.

If more than one completion is suggested, the pop-up frame may optionally be configured to present the suggestions in various ways, for example, in an alphabetical order, according to an order determined by the estimated likelihood, etc. Additionally, the frame may be configured to present the suggestions hierarchically with some kind of additional, visual clue for enhanced usability, etc. For example, the frame may present its suggestions in colors, according to a scheme defined in advance, e.g., green for highly-recommended, red for mid-range recommendation, and yellow for low probability recommendation.

In one embodiment, the client agent 116 is configured to become active and produce a pop-up frame with the suggested text only after a delay of a number of seconds in typing. The number of seconds may be specified in advance by the user. Alternatively, the pop-up frame may be configured to become active upon demand, by clicking a specific combination of keys, or via a context-sensitive menu that appears on mouse right-click. Once the one or more completion words are suggested in the pop-up frame, the client can travel through them with the help of the mouse and cursor, or with the keyboard arrows, and select the desired word by pressing, for example, “Enter” or “Tab”, or clicking with the mouse, or with the help of some other combination of keys chosen in advanced.

When the client agent 116 identifies that the a suggestion should be provided to the client, it defines a New Request for Prediction (NRP) task that is sent to the PS 114 for remote execution. The NRP task definition may be accompanied by several parameters that are either user-configured or machine-determined, as explained above. The parameters may comprise, among others, the following: (a) a Task ID; (b) the word or sentence to be completed; (c) a number of words to be added to the sentence (one or more, or an entire sentence); (d) a number of words to appear in the frame for selection (one or more, or an entire sentence); (e) a completion language (either user-determined or to be guessed as part of the prediction process); (f) a writing style.

In one alternative, the NRP task is completed by the client agent 116. For example, the agent 116a identifies a familiar form of NRP that was previously attended by the user (i.e., the desired completion was already selected by the user, and is therefore known), and therefore it knows how to complete the text. Said data for the completion, once selected, is stored in private database 115, which serves in this case like a cache, eliminating the need in some cases to access the server. The private database 115 may also store user related data which is specific to this user, such as common names that he uses, common addresses that he frequently uses, etc. Of course, in the regular operation, the NRP task is sent to the remote server 130, which responds by providing the suggestions.

After initiating a session between the client 126 and the server 130, NRP tasks are continuously produced, handled, and closed. Specifically, each time an NRP is produced, it is sent to server 130, which in turn responds by sending one or more suggestions for text completions to the client agent 116, and the NRP is closed when it becomes no longer relevant. Then, a new one is produced and said procedure repeats. In one embodiment the NRP task also contains a unique identifier of the client computer (such as its current IP address). The unique identifier is utilized by the server 130 who services plurality of clients, to identify the specific user, namely to return the appropriate answer to each task sent by the corresponding client. The client' agent 116 then opens a GUI that displays the results, as received from the server 130 in the client computer. In one alternative, the results are presented in a pop-up completion frame, as explained hereinabove. The client may then select one completion text from among the one or more completion suggestions in the GUI and thus end this part of the text-prediction process.

In still another aspect, the invention provides a method for suggesting predicted texts for completing user typing. The method is based on the use of a text-prediction database stored in the remote server, the database is created with the help of a learning process that statistically analyzes the use of words and sentences in different styles, different languages and different fields of interest, in a mass of selected websites. As mentioned hereinbefore, the analyzed data is then saved in the real time database 113 according to its context and categories. According to one embodiment, the learning process itself is based on information retrieved by the CPS 106, which crawls the Internet for relevant information. Crawling strategies in the Internet are well-known in the art.

When the CPS 106 accesses a certain website, it reads the pages of the site. The CPS is adapted to read a variety of pages such as HTML documents, PDF pages, etc. The CPS analyzes the content of the page in order to determine whether the page is relevant or not. In one embodiment, analyzing the page comprises ignoring all tags and meta-data, and focusing only on the pure text contained in the page. Determining the degree of relevancy comprises identifying that there is large enough a proportion of “real text”, as opposed to menu headers, scripts, page content information, or automatically produced text. The CPS 106 defines a page as relevant or irrelevant based on a certain percentage threshold. For example, if the percentage of text which is identified as “real text” amounts to less than the threshold, the page is classified as “irrelevant”. In addition, or alternatively, the CPS 106 defines a page as relevant or irrelevant in accordance with the absolute number of words and characters it contains.

Considerations such as length, structure, and other features of the text found in the webpage also affect the decision whether the text in question is “relevant” so that time and resources are spent in analyzing it. In an embodiment of this invention, entire pages are downloaded into the “off-line” processing system, and said analysis is performed by the CPS 106 that produces text files. The CPS 106 may also autonomously make this analysis as part of the crawling process, and then only download text files from the Web.

Once the text reaches the “off-line” processing system 103, the CPS activates a text analysis module (parser) in order to analyze it. The information from the analysis process is added to the off-line database 108. The analysis breaks the text into sentences words, and text templates.

The off-line database obtained from this analysis contains information about single words, combinations of two or more words, or entire sentences. For instance, the present invention identifies the English word “keyboard” as appearing 5000 times, the combination “ergonomic keyboard” 500 times, and the combination “Microsoft's ergonomic keyboard” 70 times. Each instance of these words and combinations of words is stored in the database together with information on the date and location, from which it was retrieved, and information on the kind of website, geographical location, language, target audience, URL, etc.

For any new entry that is added to the database, additional information and internal comparisons with other information already stored in the database is used to rate this item as more or less relevant to the analysis, or as statistically misleading. Thus, at least two kinds of statistical considerations are fundamental for building the database, namely, considerations that relate to the word or combination of words, and considerations that relate to the source websites from which they were retrieved.

In one embodiment of the invention, the entries that are added to the database are stored in tables. The tables are divided to several types according to their content. One type of table is Single-Word Table (1WT), 1WT comprises for each entry the word, word ID, and weight (i.e., number of word occurrences found by the CPS 106). Another type of table is Two-Word Combination Table (2WCT). 2WCT comprises for each entry a combination ID, ID of first word, ID of second word, weight (i.e., number of the combination occurrences found by the CPS 106). Another type of table is the Three Word Combination Table (3WCT). The 3WCT comprises for each entry a combination ID, the ID of the first word, the ID of second word, the ID of third word, the number of occurrences for this specific combination, weight (i.e., number of occurrences for this combination as found by the CPS 106), etc.

The present invention may operate with other types of tables. In one alternative, 3WCT comprises a field for a two-word combinations ID, etc. Tables of similar forms may also be maintained for combinations of any given number of words, nWord Combination Table (nWCT), for example, n represents sixteen words. There is no logical limitation to this number, and only constraints based on available resources may dictate the maximal amount of words to be considered. Performance and resource management considerations may also lead to modifying the tables for the sake of efficiency improvement, in manners well known in the art.

In one embodiment, the off-line database comprises secondary tables with similar information as the above tables, but with added constrains, such as specific geographical location, specific style, etc. In addition, the CPS 106 may produce and maintain run-time tables that are similar to the off-line database tables, but ignore some of the original information (e.g., information on the website sources, etc.). The CPS 106 may also filter out information of items that are considered as dubious under predefined criteria. For example, informal words and expressions used in the Web that have a number of appearances smaller then a predefined threshold, and therefore considered unreliable. Of course, the status of “dubious” may be changed when the information on a certain item increases and at that stage the item may be considered reliable.

In an alternative of the present invention, the client agent suggests a “fill-up template”, rather than a completed sentence. For example, when the client has typed the words “I was drinking a cup of coffee”, the CPS suggests the fill-up template “I was drinking a cup of coffee with X”, wherein the client may then accept this suggestion and write a name of his choice in the place of X. In an alternative of the present invention the text analysis module in the CPS is adapted to identify “skip” templates, and store them in the database. In skip templates the place of X is within the sentence. For example, the text analysis module identifies sentences of the type “I traveled to X in the summer”, out of instances found in websites, with X being different names of travel destinations. The CPS gives weight to each instance in its tables according to the overall number of instances found for the “skip” sentence. According to their weights the skip sentences are suggested to the client for a possible completion wherein the client can select and then complete the words where necessary.

In an alternative of the present invention, a preliminary registration session is established, where the client submits useful background information that subsequently, in communications between the client 126 and the real time server 130 is used for enhancing the quality of the service in forthcoming requests. Such background information relates to the user parameters such as age, gender, occupation, country of residence, etc. In addition, within a particular session, the client may submit additional parameters to be used temporarily during that specific session for the same purposes of quality enhancing.

In still another alternative, the additional information comprises parameters that relate to writing style, content, application currently in use (e.g., WORD, email, SMS,), language, etc. This information is submitted to the PS 114 via the GUI presented to the client and the communication interfaces between the client agent and the PS 114. In one alternative, this communication interface is a network communication interface as known in the art. In one embodiment, the additional information is stored within server 130. In another embodiment, the additional information is stored within the user own computer 126. For example, once the client selects the completion text among various suggested texts, the client agent 116 may update the PS 130 about this selection, or may save this information in the memory of the user computer for use in the future. Relevant information comprises items which relate to the user preferred style, the kind of words or sentences he accepted or rejected, etc.

Regardless to the existence of the background information, when the client starts writing in some text-oriented application running in his computer 126, as explained above, the Client agent 116 creates NRP tasks one after the other and sends them to the PS 114. The PS 114 receives the NRP tasks and launches an internal task and process meant to service this NRP request. The process turns to the database 113 (with the assistance of the background information if provided by the client—general or per session). The PS 114 comes up with one or more suggestions, according to the parameters of the request and those defined in advance for this user and optionally for the session. The suggestions for the text prediction are then sent back to the client agent 116, and the process that initiated the request, which may meanwhile either be on hold or actively waiting, receives the suggestions and displays them on the GUI as explained hereinabove.

In some cases the application in which the client is writing the text does not run in the user computer, but rather in some remote server. In such cases, the NRP is sent to the PS 114 from the remote server. For example, the client opens a browser in his computer and types a text in a Web mail application, the server that runs the mail application is the one that runs the client gent 116 for the purpose of prediction as described hereinabove. Similar situations arise in the case of social-networking or blog-oriented sites. In this embodiment, the client agent 116 and its prediction services are available to all the users of the specific site associated with said server, and not only to the users that installed the text prediction system of the present invention in their own computers.

The system according to the present invention is adapted to work also with text handling applications (such as voice recognition or OCR), for the purposes of verification, quality assurance, etc. The system according to the present invention can also be utilized for spell-checking, syntax and style correction, cellular telephones and handheld devices text completion, Artificial Intelligence (AI) technology and expert Systems, such as voice recognition, and automatic machine translation, quality assurance methods for text based industry and services, such as newspapers, on-line support, legal services, etc.

The above examples and description have been provided only for the purpose of illustration, and are not intended to limit the invention in any way. As will be appreciated by the skilled person, the invention can be carried out in a great variety of ways, employing more than one technique from those described above, all without exceeding the scope of the invention.

1. A computerized system for predicting completions to input text which is typed by a user to a text-oriented active application within a client computer, comprising:
a) an off-line server that gathers texts from textual repositories, analyzes and processes the same to produce entries for an off-line database, said off-line server updates periodically a real time database of a real time server;
b) a real-time prediction server for receiving from an agent at said client computer serial requests for predictions, extracting in response to each of said requests one or more text predictions from tables within said real time database, and for conveying said one or more text predictions to said agent, wherein each of said text predictions comprises one or more words;
c) said real time database which comprises one or more tables containing word combination entries of various sizes, wherein each of said entries is associated with a weight which is used to estimate the probability for this combination to complete the typed text as included in the respective request for prediction; and
d) said agent which extracts in real time each present user typing to said text-oriented application, produces requests for prediction for new typing, sends the same to said prediction server, receives in response said one or more text predictions, and presents to said user said one or more text predictions for selection.

2. A system according to claim 1, wherein said text predictions are taken from the group consisting of: one or more words, a sentence, and a paragraph,

3. A system according to claim 1, wherein one or more of said requests for predictions contain user personal data, wherein said real time database comprises plurality of characteristic sub-databases, and wherein said prediction server selects one or more specific sub-database based on said personal data.

4. A system according to claim 1, wherein said real time database comprises plurality of characteristic sub-databases, and wherein said prediction server evaluates the user typing as included in said requests to determine the most appropriate one or more sub-databases to use for extracting said text predictions.

5. A system according to claim 4, wherein said characteristic sub-databases are differentiated by jargon, language, user profile, and type of application.

6. A system according to claim 1, wherein said textual repositories are Internet web sites to which said off line server crawls, and extracts text from pages of said web sites.

7. A system according to claim 1, wherein some entries that are produced by the off-line server include variables that are thereafter replaced at the client computer either by the user or by the agent.

8. A system according to claim 1, wherein the text predictions are introduced to the user within a GUI at the active application.

9. A system according to claim 1 which also comprises a dictionary for a second language, and wherein the client, agent also displays to the user within the GUI a translation of the text predictions to said second language.

10. A system according to claim 1 wherein the agent is application-independent, and wherein it is adapted to determine and operate on said one active application from among the plurality of applications that are operative at the user computer.

11. A system according to claim 1, wherein the tables contain word combinations of between one word length for completing one word, and up to a length of several hundreds of words for completing entire paragraph.

12. A system according to claim 1, for use in an organization, which further comprises an organizational real time server which in turn comprises an internal real time database, said internal real time database comprises terms, words, and expressions that are specific to the organization, and wherein said organizational real time server further communicates with said real time server for providing together text predictions to the client.

13. A method for suggesting completions for an input text typed to a text-oriented application running at a user computer, the method comprising:
a. receiving input text from a text input device;
b. defining, based on the input text, a request for prediction task in the computer system;
c. sending the request to prediction to a remote real time prediction server for remote execution;
d. extracting by said prediction server from a real time database one or more text predictions, and sending them to an agent within a user computer; and
e. receiving said one or more text predictions by said agent, and displaying them to the user for selection.

14. A system according to claim 1, wherein the real time server comprises:
a. a parser for breaking each received request into a context section which comprises previously typed words, and a hint section which comprises the presently typed word or a portion thereof, said context and hint portions are used for retrieving prediction alternatives from the real time database;
b. a merging unit for selecting and prioritizing best predictions to be sent to the user, said merging unit operates by applying logic rules as received from a rule base; and
c. a rule base which comprises logic rules for said merging unit.

15. A system according to claim 9, further comprising a self improving mechanism for continuously tuning and improving said rule base based on historical client previous requests, responses of the prediction server to said requests, and reaction of the user to these responses.
